(19) United States
(12) Patent Application Publication
(10) Pub. No.: US 2022/0306093 A1
(43) Pub. Date: Sep. 29, 2022

(54) ENHANCED VEHICLE OPERATION

(71) Applicant: Ford Global Technologies, LLC, Dearborn, MI (US)

(72) Inventors: Himanshu Verma, Farmington Hills, MI (US); Fling Finn Tseng, Ann Arbor, MI (US)

(73) Assignee: Ford Global Technologies, LLC, Dearborn, MI (US)

(21) Appl. No.: 17/210,987

(22) Filed: Mar. 24, 2021

(51) Int. Cl. B60W 30/095; B60W 30/09; B60W 60/00; B60W 30/18; G06K 9/00; H04W 4/46

(52) U.S. Cl. CPC B60W 30/0956; B60W 30/09; B60W 60/0018; B60W 30/18109; G06K 9/00798; H04W 4/46; B60W 2552/53; B60W 2554/4049; B60W 2554/4041

(57) ABSTRACT

An arrival time of a primary vehicle to arrive at a stopping location is predicted based a current path of the primary vehicle. A predicted transit time period of a secondary vehicle to move to the stopping location is received. Upon determining that a current time is a time that is the predicted transit time period subtracted from the arrival time, a message is sent from the primary vehicle to the secondary vehicle instructing the secondary vehicle to move to the stopping location.

### BACKGROUND

Vehicles can be equipped with computing devices, networks, sensors, and controllers to acquire data regarding the vehicle's environment and to operate the vehicle based on the data. Sensors can provide data to detect features of the environment, such as markings on a road or other travel surface, road signs, objects such as other vehicles or obstacles such as rocks or debris, etc. Sensor data can be provided over a vehicle network to one or more controllers or other computers on the vehicle network. Vehicle sensors can thus provide data as a vehicle travels to a destination, e.g., to determine a path or possible paths to the destination.

### BRIEF DESCRIPTION OF THE DRAWINGS

FIG. 1 is a block diagram of an example system for operating a vehicle.

FIG. 2 is a top-down view of an example map including a stopping location for the vehicle.

FIG. 3 is a diagram of the vehicle and a secondary vehicle moving to the stopping location.

FIG. 4 is a diagram of an example clustering program.

FIG. 5 is a block diagram of an example process for operating the vehicle.

### DETAILED DESCRIPTION

A system includes a computer including a processor and a memory, the memory storing instructions executable by the processor to predict an arrival time of a primary vehicle to arrive at a stopping location based a current path of the primary vehicle, receive a predicted transit time period of a secondary vehicle to move to the stopping location, and, upon determining that a current time is a time that is the predicted transit time period subtracted from the arrival time, send a message from the primary vehicle to the secondary vehicle instructing the secondary vehicle to move to the stopping location.

The instructions can further include instructions to output the stopping location from a clustering program trained to predict the stopping location based on the current path of the primary vehicle.

The clustering program can be trained to assign an input path of the primary vehicle to one of a plurality of clusters, each cluster including a location at which the primary vehicle previously stopped, and the instructions can further include instructions to identify the stopping location as the location included in the assigned cluster.

The instructions can further include instructions to determine the stopping location based on a previously determined location at which the primary vehicle stopped.

The instructions can further include instructions to predict the arrival time based on a time of arrival at the previously determined location.

The instructions can further include instructions to, after receiving the predicted transit time period, receive a secondary predicted transit time period of the secondary vehicle to move to the stopping location and, upon determining that the current time is a time that is the secondary predicted transit time period subtracted from the arrival time, send the message from the primary vehicle to the secondary vehicle instructing the secondary vehicle to move to the stopping location.

The instructions can further include instructions to predict the arrival time based on a path-planning program.

The instructions can further include instructions to plan a path from a current location of the primary vehicle to the stopping location with the path-planning program and to predict the arrival time based on the planned path.

The instructions can further include instructions to send the stopping location and the predicted arrival time to an external server programmed to predict the transit time period for the secondary vehicle.

The external server can be further programmed to identify the secondary vehicle as a secondary vehicle available to transport one or more users of the primary vehicle and to instruct the secondary vehicle to move to the stopping location.

The instructions can further include instructions to predict the arrival time based on a traffic rate on a roadway between a current location of the primary vehicle and the stopping location.

The instructions can further include instructions to identify the stopping location based on a stored location at which the primary vehicle previously stopped and a current trajectory of the primary vehicle.

A method includes predicting an arrival time of a primary vehicle to arrive at a stopping location based on a current path of the primary vehicle, receiving a predicted transit time period of a secondary vehicle to move to the stopping location, and, upon determining that a current time is a time that is the predicted transit time period subtracted from the arrival time, sending a message from the primary vehicle to the secondary vehicle instructing the secondary vehicle to move to the stopping location.

The method can further include outputting the stopping location from a clustering program trained to predict the stopping location based on the current path of the primary vehicle.

The clustering program can be trained to assign an input path of the primary vehicle to one of a plurality of clusters, each cluster including a location at which the primary vehicle previously stopped, and the method can further include identifying the stopping location as the location included in the assigned cluster.

The method can further include determining the stopping location based on a previously determined location at which the primary vehicle stopped.

The method can further include predicting the arrival time based on a time of arrival at the previously determined location.

The method can further include, after receiving the predicted transit time period, receiving a secondary predicted transit time period of the secondary vehicle to move to the stopping location and, upon determining that the current time is a time that is the secondary predicted transit time period subtracted from the arrival time, sending the message from the primary vehicle to the secondary vehicle instructing the secondary vehicle to move to the stopping location.

The method can further include predicting the arrival time based on a path-planning program.

The method can further include planning a path from a current location of the primary vehicle to the stopping location with the path-planning program and predicting the arrival time based on the planned path.

The method can further include sending the stopping location and the predicted arrival time to an external server programmed to predict the transit time period for the secondary vehicle.

The external server can be further programmed to identify the secondary vehicle as a secondary vehicle available to transport one or more users of the primary vehicle and to instruct the secondary vehicle to move to the stopping location.

The method can further include predicting the arrival time based on a traffic rate on a roadway between a current location of the primary vehicle and the stopping location.

The method can further include identifying the stopping location based on a stored location at which the primary vehicle previously stopped and a current trajectory of the primary vehicle.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

A primary vehicle arriving at a destination (sometimes referred to herein as an “arriving vehicle”) may be required to stop at a primary vehicle stopping location that is different from, a potentially far from, a user's final destination, and then use a secondary vehicle to move from the primary vehicle stopping location to the final destination. For example, a stopping location may be unavailable or impractical close to the intended final destination. To increase efficiencies of arriving vehicles and/or secondary vehicles, a computer in a primary arriving vehicle can predict an arrival time of the primary vehicle at vehicle destination. Upon providing the predicted arrival time to a central server, the primary vehicle can then receive from the central server a predicted transit time period of the secondary vehicle to the primary vehicle stopping location. Then, at a time that is the predicted transit time period subtracted from the arrival time, the computer can send a request to the secondary vehicle to move to the primary vehicle stopping location, such that the secondary vehicle can arrive at the primary vehicle stopping location at the arrival time with the vehicle. The computer can use data from one or more sensors of the vehicle to predict the arrival time and the primary vehicle stopping location, e.g., a vehicle speed, a vehicle trajectory, etc. The computer can use a machine leaning program, such as a clustering program, to predict the primary vehicle stopping location based on the data from the vehicle sensors. Thus, the computer can use vehicle data to preemptively determine to provide a secondary vehicle to move the primary vehicle user to move to the final destination and request the secondary vehicle to arrive at the primary vehicle stopping location when the vehicle arrives, reducing the time spent by the user to reach the final destination.

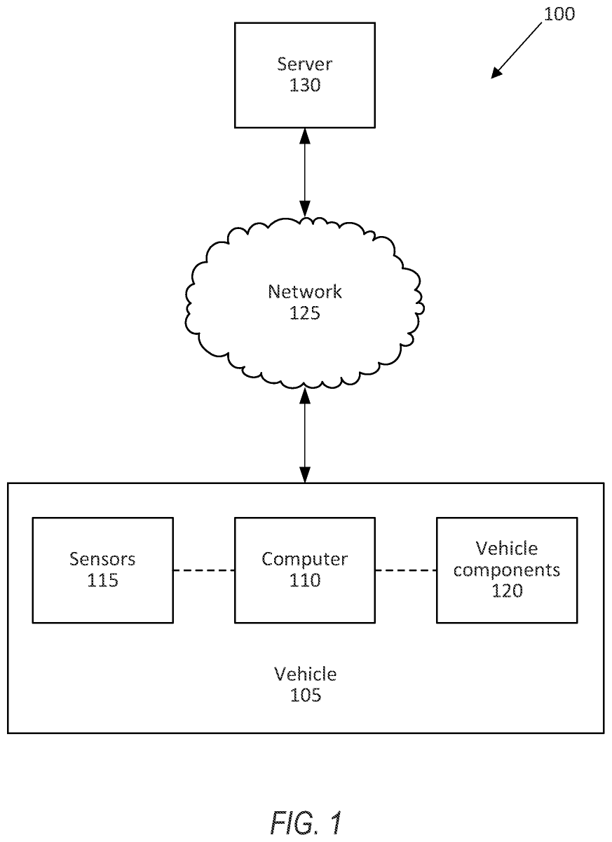

FIG. 1 illustrates an example system 100 for operating a vehicle 105. A computer 110 in the vehicle 105 is programmed to receive data from one or more sensors 115. For example, vehicle 105 sensor data may include a location of the vehicle 105, data about an environment around a vehicle, data about an object outside the vehicle such as another vehicle, etc. A vehicle 105 location is typically provided in a conventional form, e.g., geo-coordinates such as latitude and longitude coordinates obtained via a navigation system that uses the Global Positioning System (GPS). Further examples of data provided to a vehicle computer 110 can include measurements of vehicle 105 systems and components, e.g., a vehicle 105 velocity, a vehicle 105 trajectory, etc.

The computer 110 is generally programmed for communications on a vehicle 105 network, e.g., including a conventional vehicle 105 communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include an electronic control unit (ECU) or controller or the like for a specific function or set of functions, and/or a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle 105 network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected in a vehicle 105. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, each vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 120 can include computing devices, e.g., electronic control units (ECUs) or the like and/or computing devices such as described above with respect to the computer 110, and that likewise communicate via a vehicle 105 network.

A vehicle 105 can operate in one of a fully autonomous mode, a semiautonomous mode, or a non-autonomous mode. A fully autonomous mode is defined as one in which each of vehicle 105 propulsion (typically via a powertrain including an electric motor and/or internal combustion engine), braking, and steering are controlled or monitored by the computer 110. A semi-autonomous mode is one in which at least one of vehicle 105 propulsion (typically via a powertrain including an electric motor and/or internal combustion engine), braking, and steering are controlled or monitored at least partly by the computer 110 as opposed to a human user. In a non-autonomous mode, i.e., a manual mode, the vehicle 105 propulsion, braking, and steering are controlled by the human user.

The system 100 can further include a network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

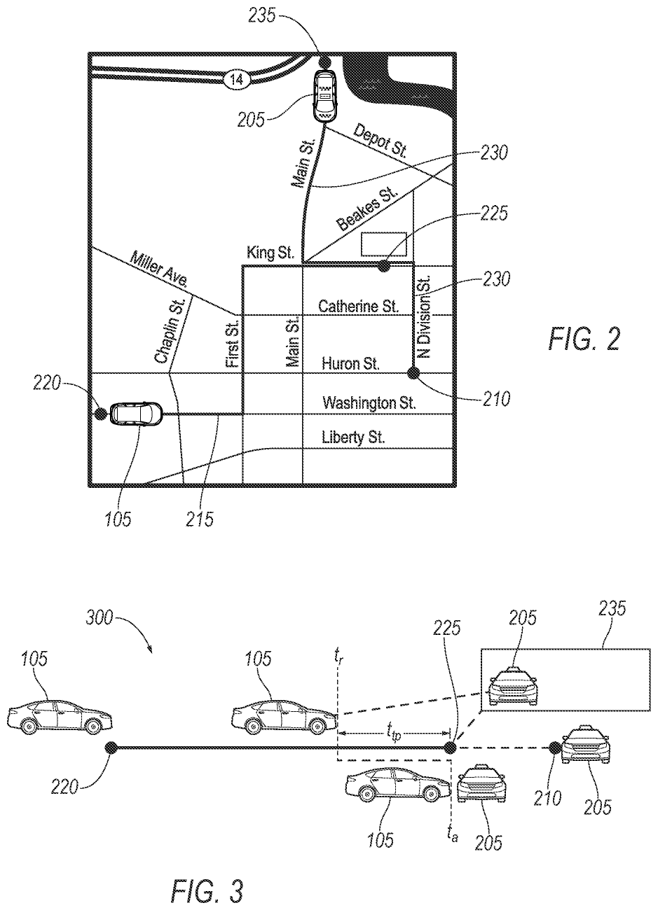

FIG. 2 is a top-down view of a map 200. The map 200 shows a primary vehicle 105 and a secondary vehicle 205. The “secondary vehicle” 205 is a vehicle that can transport one or more passengers, such as a bus, van, sedan, etc. The secondary vehicle 205 can transport a user of the primary vehicle 105 to a final destination 210. That is, the user may park the primary vehicle 105 at a primary vehicle stopping location 225, e.g., a parking lot or parking structure, and the secondary vehicle 205 may transport the user from the stopping location 225 to the final destination 210 of the user.

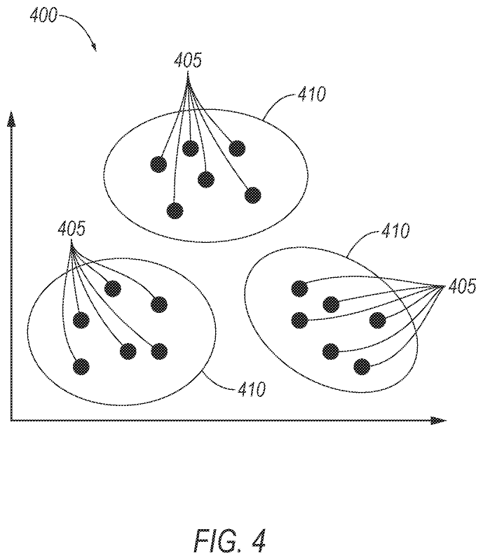

The primary vehicle 105 can move along a path 215 from an origin 220 to a stopping location 225. The computer 110 can predict the path 215 based on previously traveled paths 215 of the primary vehicle 105, current location data of the primary vehicle 105, and/or previously traveled stopping locations 225. For example, the computer 110 can predict the path 215 with a clustering program, such as described below and shown in FIG. 4. The clustering program can assign input data to one of a plurality of clusters, each cluster assigned to a previously determined path 215 and stopping location 225 stored in the memory of the computer 110. That is, the computer 110 can input data about the primary vehicle 105, e.g., a vehicle speed, a vehicle trajectory, etc., to the clustering program, and the clustering program can determine a distance (e.g., a Euclidean distance, a Mahalanobis distance, etc.) between the input data and data in the clusters. Then, the clustering program can identify the cluster having the smallest distance from the input data and output the path 215 and the stopping location 225 associated to the cluster.

The computer 110 can predict an arrival time for the primary vehicle 105 to arrive at the stopping location 225. The computer 110 can predict the arrival time, i.e., can predict a future time at which the primary vehicle 105 will arrive at the stopping location 225. The computer 110 can predict the arrival time based on a current path 215 of the primary vehicle 105. That is, the computer 110 can predict the path 215, as described above, and the path 215 can include a distance between a current location of the primary vehicle 105 and the stopping location 225. The computer 110 can determine the arrival time using existing techniques for predicting arrival times (e.g., as available at sites such as maps.google.com) based on, e.g., the distance and a posted speed limit of the roadway long the path 215, traffic conditions, weather conditions, etc., i.e., the computer 110 can determine, based on factors such as the posted speed limit(s) that the primary vehicle 105 is expected to follow, and the distance between the current location of the primary vehicle 105 and the stopping location 225, a predicted time period that would elapse until the primary vehicle 105 reaches the stopping location 225. The computer 110 can add the predicted time period to a current time to predict the arrival time. Additionally or alternatively, the computer 110 can predict the arrival time based on factors such as a traffic rate on the roadway along the path 215. That is, the computer 110 can use a conventional path-planning program that accounts for a traffic rate received from a server 130 to predict the arrival time of the primary vehicle 105 at the stopping location 225. Yet alternatively or additionally, the computer 110 can predict the arrival time based on a previous time of arrival at the stopping location 225. That is, the computer 110 can store in a memory times and stopping locations 225 from previous trips, and when the computer 110 predicts that the primary vehicle 105 is traveling to a stopping location 225 at which the primary vehicle 105 has previously stopped, the computer 110 can retrieve the stored times and predict the arrival time as one of the stored times.

The secondary vehicle 205 can travel along a path 230 from an origin 235 to the stopping location 225. The origin 235 of the path 230 of the secondary vehicle 205 can be a location at which the secondary vehicle 205 is located upon receiving an instruction to move to the stopping location 225. For example, the origin 235 could be a current location of a secondary vehicle 205 on a roadway, or, in another example, could be a storage facility or lot for a fleet of secondary vehicles 205 managed by a server 130. The server 130 can determine the path 230 based on a current location of the secondary vehicle 205 and the stopping location 225. The server 130 can determine the path 230 based on, e.g., a path planning program such as a path polynomial.

The server 130 can, based on the path 230, determine a predicted transit time period for the secondary vehicle 205 to move from the origin 235 to the stopping location 225. A “transit time period” is a number of time units (e.g., a number of minutes) that are expected to elapse as the secondary vehicle 205 travels to the stopping location 225. The server 130 can transmit the predicted transit time period to the computer 110 of the primary vehicle 105 via the network 125. The server 130 can determine the predicted transit time period for the secondary vehicle 205 based on a transit time algorithm. The transit time algorithm receives as input the current location of the secondary vehicle 205 and the stopping location 225 and determines a predicted time that will elapse for the secondary vehicle 205 to arrive at the stopping location 225. The transit time algorithm can be one of a plurality of conventional techniques, such as algorithms used by Google, Uber®, Lyft®, Curb®, etc., that can determine the predicted transit time period. For example, the transit time algorithm can be an Estimated Time of Arrival (ETA) algorithm using a routing engine and contraction hierarchies to predict the transit time period, such as described at https://eng.uber.com/engineering-routing-engine/ (accessed Feb. 22, 2021). The transit time algorithm can predict the transit time period based on a plurality of other factors, e.g., a traffic rate (i.e., a number of cars on the roadway), posted speed limits, road closure information in a global map database, etc. Upon receiving the occupants of the primary vehicle 105 at the stopping location 225, the secondary vehicle 205 can move the occupants to the destination 210.

The computer 110 can send the stopping location 225 to the server 130 via the network 125, and the server 130 can predict the transit time period for the secondary vehicle 205 based on the received stopping location 225. The server 130 can identify a secondary vehicle 205 closest to the stopping location 225 received from the computer 110 and predict the transit time period of the secondary vehicle 205 to the stopping location 225, as described above. That is, the server 130 can receive location data from each of a plurality of secondary vehicles 205 in a fleet, and the server 130 can compare the location data of the secondary vehicles 205 to the received stopping location 225. The computer 110 can identify one of the secondary vehicles 205 available to transport one or more users of the primary vehicle 105 and can instruct the secondary vehicle 205 to move to the stopping location 225.

The computer 110 can, while moving to the stopping location 225, receive a secondary predicted transit time period of the secondary vehicle 205. The server 130 can collect traffic data of the roadway between the current location of the secondary vehicle 205 and the stopping location 225, and, based on the transit time algorithm described above, determine the secondary predicted transit time period for the secondary vehicle 205 to arrive at the stopping location 225. That is, as traffic rates change while the primary vehicle 105 and the secondary vehicle 205 approach the stopping location 225, the predicted time that will elapse for the secondary vehicle 205 to reach the stopping location 225 can change, and the transit time algorithm can determine the secondary predicted transit time period based on the change in traffic rate. The server 130 can send the secondary predicted transit time period to the computer 110 via the network 125.

The computer 110 can determine a request time send a message to the server 130 and/or the secondary vehicle 205 instructing the secondary vehicle 205 to move to the stopping location 225. The “request time” is a time at which the computer 110 can send the message to the secondary vehicle 205. The computer 110 can determine the request time based on the predicted transit time period received from the server 130 and/or the secondary vehicle 205. That is, the computer 110 can send the message requesting the secondary vehicle 205 such that the secondary vehicle 205 and the primary vehicle 105 will arrive at the stopping location at approximately the same time, reducing the amount of time that either the primary vehicle 105 or the secondary vehicle 205 wait at the stopping location 225. The computer 110 can determine the request time as the predicted transit time period subtracted from the arrival time. That is, upon sending the message at the determined time, the arrival time of the primary vehicle 105 can be the same time as the time at which the secondary vehicle 205 arrives at the stopping location 225. For example, if the predicted arrival time of the primary vehicle 105 is 5:30, and the predicted transit time period is 10 minutes, the computer 110 can determine the request time to be 5:20 and send the message requesting the secondary vehicle 105 at the request time. The primary vehicle 105 and the secondary vehicle 205 can then both arrive at the stopping location 225 at 5:30.

FIG. 3 is a diagram 300 of a primary vehicle 105 and a secondary vehicle 205 moving to a stopping location 225 to move one or more users of the primary vehicle 105 to a destination 210. The diagram 300 illustrates the arrival time tₐ, of the primary vehicle 105 at the stopping location 225, the predicted transit time period tₜₚ for the secondary vehicle 205 to arrive at the stopping location 225, and the request time tᵣ at which the computer 110 requests the secondary vehicle 205. As described above, the primary vehicle 105 begins at the origin 220 and moves toward the stopping location 225. The computer 110 can predict the arrival time tₐ, of the primary vehicle 105 at the stopping location 225 based on a predicted path 215 of the primary vehicle 105.

The computer 110 sends the stopping location 225 to the server 130 and/or the secondary vehicle 205 at its origin 235, e.g., a storage location for a fleet of secondary vehicles 205. The server 130 and/or the secondary vehicle 205 then predicts the transit time period tₜₚ for the secondary vehicle 205 to arrive at the stopping location 225 based on a transit time algorithm, as described above. The server 130 and/or the secondary vehicle 205 can send the predicted transit time period tₜₚ to the computer 110 via the network 125.

The computer 110 can determine the request time tᵣ by subtracting the transit time period tₜₚ from the arrival time tₐ, as described above. Then, when a current time is the request time tᵣ, the computer 110 can transmit a message over the network 125 to the server 130 and/or the secondary vehicle 205 instructing the secondary vehicle 205 to move to the stopping location 225. Thus, when the transit time period tₜₚ elapses, the primary vehicle 105 and the secondary vehicle 205 should arrive at the stopping location 225, and the secondary vehicle 205 can move the occupants of the primary vehicle 105 to the destination 210.

FIG. 4 is a diagram 400 of an example clustering program that assigns input data points 405 to one of a plurality of clusters 410. In this context, a “clustering program” is a machine learning program that receives input data 405 and, based on a distance between the input data 405 and previously input data 405, assigns the input data 405 to one of a plurality of clusters 410. A “cluster” is a group of data 405 that share a characteristic that the clustering program is trained to identify. For example, the input data 405 can be location and speed data from a vehicle 105, and the clusters 410 can be each be one of a plurality of stopping locations 225 at which the primary vehicle 105 has previously stopped and a path 215 from the origin 220 to the stopping location 225. For example, the clusters 410 can include predicted stopping locations 225 for a specified time and location of initiation of the vehicle 105. Then, each cluster 410 for a specific predicted stopping location 225 can include one predicted path 215 from the origin 220 the stopping location 225. Based on data input to the clustering program, as described below, the clustering program can assign the data to one of the clusters 410 and output the predicted stopping location 225 and the predicted path 215. The clustering program can be programming of the computer 110 of the primary vehicle 105.

The computer 110 can, upon leaving the origin 220, collect data from a plurality of sensors 115 and/or an external server 130. The data can include, e.g., a vehicle speed, a vehicle trajectory, a heading angle, geo-location traces from the external server 130, etc. The computer 110 can input the data to the clustering program as input data 405. The clustering program can determine a distance between the input data 405 and data 405 in each of the clusters 410. For example, the distance can be a Euclidean distance between the input data 405 and the data 405 in the clusters 410. In another example, the distance can be a Mahalanobis distance between the input data 405 and the data 405 in the clusters 410. The distance to one of the clusters 410 is a measure of a probability that a current path 215 and stopping location 220 to which the vehicle 105 moves is the path 215 and stopping location 220 associated to that one of the clusters 410. The clustering program can identify the cluster 410 that has the smallest determined distance to the input data 405 and assign the input data 405 to the identified cluster 410. The clustering program can output the identified cluster 410 and the path 215 and the stopping location 225 assigned to the identified cluster 410. Then, as described above, the computer 110 can determine the arrival time based on the path 215 to the stopping location 225 and request the secondary vehicle 205 based on the arrival time.

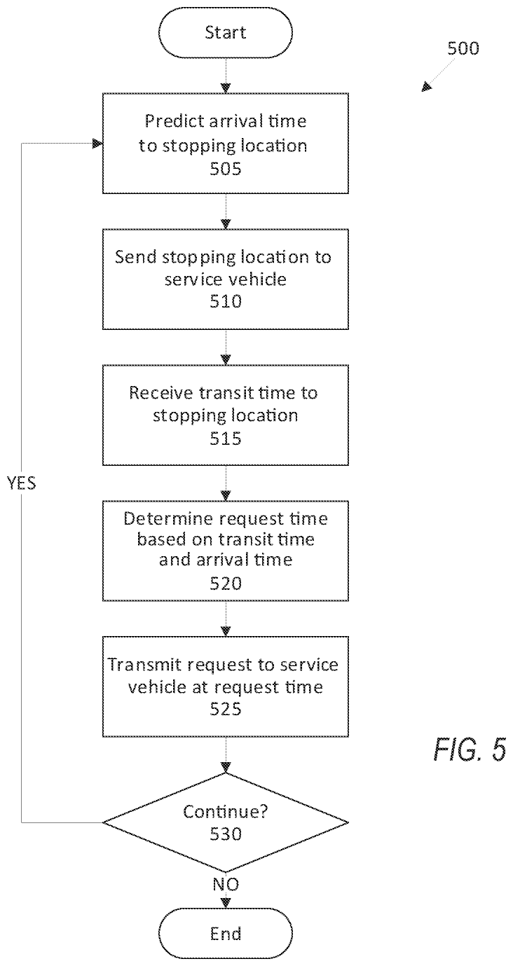

FIG. 5 is a block diagram of an example process 500 for operating a primary vehicle 105 to move an occupant. The process 500 begins in a block 505, in which a computer 110 of the primary vehicle 105 predicts an arrival time of the primary vehicle 105 to a stopping location 225 based on a current location of the primary vehicle 105, i.e., a path origin. As described above, the stopping location 225 can be a location at which the primary vehicle 105 stops while the occupant moves to a destination 210. For example, the stopping location 225 can be, e.g., a parking lot, a parking garage, etc. The computer 110 can predict the arrival time based on a predicted path 215 of the primary vehicle 105. For example, the computer 110 can determine the arrival time based on the distance and a posted speed limit of the roadway along the path 215, i.e., the computer 110 can determine, based on the posted speed limit that the primary vehicle 105 follows and the distance between the current location of the primary vehicle 105 and the stopping location 225, a predicted time period that would elapse until the primary vehicle 105 reaches the stopping location 225. The computer 110 can add the predicted time period to a current time to predict the arrival time.

Next, in a block 510, the computer 110 can send the stopping location 225 to a secondary vehicle 205. As described above, the secondary vehicle 205 can move the occupant of the primary vehicle 105 from the stopping location 225 to the destination 210. The computer 110 can send a message including the stopping location 225 to a computer of the secondary vehicle 205 and/or a server 130 managing a fleet of secondary vehicles 205 that is in communication with the secondary vehicle 205.

Next, in a block 515, the computer 110 receives a predicted transit time period for the secondary vehicle 205 to arrive at the stopping location 225. As described above, the server 130 and/or the secondary vehicle 205 can determine the predicted transit time period according to a transit time algorithm such as discussed above. The transit time algorithm can receive as input the current location of the secondary vehicle 205 and the stopping location 225 and can determine a predicted time that will elapse for the secondary vehicle 205 to arrive at the stopping location 225. The server 130 and/or the secondary vehicle 205 can then send the predicted transit time period to the computer 110 via the network 125.

Next, in a block 520, the computer 110 determines a request time based on the transit time and the arrival time. The request time is a time at which the computer 110 can send a request to the server 130 and/or the secondary vehicle 205, the request including instructions for the secondary vehicle 205 to move to the stopping location 225. The computer 110 can determine the request time as the predicted transit time period subtracted from the arrival time.

Next, in a block 525, the computer 110 transmits the request to the server 130 and/or the secondary vehicle 205 at the request time. As described above, the computer 110 can compare a current time to the request time and, when the current time is at or after the request time, the computer 110 can send a message including the request to the server 130 and/or the secondary vehicle 205 via the network 125.

Next, in a block 530, the computer 110 determines whether to continue the process 500. For example, the computer 110 can determine not to continue the process 500 upon arriving at the stopping location 225 and powering off. In another example, the computer 110 can determine to continue the process 500 upon determining a new stopping location 225 for the primary vehicle 105. If the computer 110 determines to continue, the process 500 returns to the block 505. Otherwise, the process 500 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

Ordinal adjectives such as “primary” and “secondary” are used throughout this document as identifiers and are not intended to signify importance or order.

1. A system, comprising a computer including a processor and a memory, the memory storing instructions executable by the processor to:
predict an arrival time of a primary vehicle to arrive at a stopping location based a current path of the primary vehicle;
receive a predicted transit time period of a secondary vehicle to move to the stopping location; and
upon determining that a current time is a time that is the predicted transit time period subtracted from the arrival time, send a message from the primary vehicle to the secondary vehicle instructing the secondary vehicle to move to the stopping location.

2. The system of claim 1, wherein the instructions further include instructions to output the stopping location from a clustering program trained to predict the stopping location based on the current path of the primary vehicle.

3. The system of claim 2, wherein the clustering program is trained to assign an input path of the primary vehicle to one of a plurality of clusters, each cluster including a location at which the primary vehicle previously stopped, and the instructions further include instructions to identify the stopping location as the location included in the assigned cluster.

4. The system of claim 1, wherein the instructions further include instructions to determine the stopping location based on a previously determined location at which the primary vehicle stopped.

5. The system of claim 4, wherein the instructions further include instructions to predict the arrival time based on a time of arrival at the previously determined location.

6. The system of claim 1, wherein the instructions further include instructions to, after receiving the predicted transit time period, receive a secondary predicted transit time period of the secondary vehicle to move to the stopping location and, upon determining that the current time is a time that is the secondary predicted transit time period subtracted from the arrival time, send the message from the primary vehicle to the secondary vehicle instructing the secondary vehicle to move to the stopping location.

7. The system of claim 1, wherein the instructions further include instructions to predict the arrival time based on a path-planning program.

8. The system of claim 7, wherein the instructions further include instructions to plan a path from a current location of the primary vehicle to the stopping location with the path-planning program and to predict the arrival time based on the planned path.

9. The system of claim 1, wherein the instructions further include instructions to send the stopping location and the predicted arrival time to an external server programmed to predict the transit time period for the secondary vehicle.

10. The system of claim 9, wherein the external server is further programmed to identify the secondary vehicle as a secondary vehicle available to transport one or more users of the primary vehicle and to instruct the secondary vehicle to move to the stopping location.

11. The system of claim 1, wherein the instructions further include instructions to predict the arrival time based on a traffic rate on a roadway between a current location of the primary vehicle and the stopping location.

12. The system of claim 1, wherein the instructions further include instructions to identify the stopping location based on a stored location at which the primary vehicle previously stopped and a current trajectory of the primary vehicle.

13. A method, comprising:
predicting an arrival time of a primary vehicle to arrive at a stopping location based on a current path of the primary vehicle;
receiving a predicted transit time period of a secondary vehicle to move to the stopping location; and
upon determining that a current time is a time that is the predicted transit time period subtracted from the arrival time, sending a message from the primary vehicle to the secondary vehicle instructing the secondary vehicle to move to the stopping location.

14. The method of claim 13, further comprising outputting the stopping location from a clustering program trained to predict the stopping location based on the current path of the primary vehicle.

15. The method of claim 13, further comprising determining the stopping location based on a previously determined location at which the primary vehicle stopped.

16. The method of claim 13, further comprising, after receiving the predicted transit time period, receiving a secondary predicted transit time period of the secondary vehicle to move to the stopping location and, upon determining that the current time is a time that is the secondary predicted transit time period subtracted from the arrival time, sending the message from the primary vehicle to the secondary vehicle instructing the secondary vehicle to move to the stopping location.

17. The method of claim 13, further comprising predicting the arrival time based on a path-planning program.

18. The method of claim 13, further comprising sending the stopping location and the predicted arrival time to an external server programmed to predict the transit time period for the secondary vehicle.

19. The method of claim 13, further comprising predicting the arrival time based on a traffic rate on a roadway between a current location of the primary vehicle and the stopping location.

20. The method of claim 13, further comprising identifying the stopping location based on a stored location at which the primary vehicle previously stopped and a current trajectory of the primary vehicle.
